(19) United States
(12) Patent Application Publication
(10) Pub. No.: US 2013/0091262 A1
(43) Pub. Date: Apr. 11, 2013

(54) SOCIAL ACCESS CONTROL

(71) Applicants: Yasantha N. Rajakarunanayake, San Ramon, CA (US); Wael William Diab, San Francisco, CA (US)

(72) Inventors: Yasantha N. Rajakarunanayake, San Ramon, CA (US); Wael William Diab, San Francisco, CA (US)

(73) Assignee: BROADCOM CORPORATION, IRVINE, CA (US)

(21) Appl. No.: 13/536,516

(22) Filed: Jun. 28, 2012

Related U.S. Application Data
(60) Provisional application No. 61/545,147, filed on Oct. 8, 2011.

(51) Int. Cl. G06F 15/173

(52) U.S. Cl. 709/223

(57) ABSTRACT

A social networking (SNET) management service supports interactions involving various resources, which can include applications, services, and identities, of members associated with a SNET infrastructure. A SNET management service can be centrally located or distributed across various devices associated with a SNET infrastructure. The SNET management service can support managing a SNET group, in part or in full, by various server devices and devices docked to the SNET group. Supported interactions can include docking resources to a SNET group and extending access by various members associated with various SNET infrastructures to such resources. Various interactions can also include extending access by docked resources, resources associated with docked devices, and the like, to members associated with various SNET infrastructures. Various interactions can be managed based upon inputs, internal logic, and the like provided by various processing systems, devices, and/or members.

### CROSS REFERENCE TO RELATED PATENTS/PATENT APPLICATIONS

### Provisional Priority Claim

The present U.S. Utility patent application claims priority pursuant to 35 U.S.C. §119(e) to the following U.S. Provisional patent application which is hereby incorporated herein by reference in its entirety and made part of the present U.S. Utility patent application for all purposes:
1. U.S. Provisional Patent Application Ser. No. 61/545,147, entitled “Social Network Device Memberships and Resource Allocation,” (Attorney Docket No. BP23771), filed Oct. 8, 2011, pending.

### INCORPORATION BY REFERENCE

The following U.S. Utility patent applications are hereby incorporated herein by reference in their entirety and made part of the present U.S. Utility patent application for all purposes:
1. U.S. application Ser. No. 13/342,301, filed Jan. 3, 2012, and entitled, “Social Network Device Memberships and Applications,” (Attorney Docket No. BP23771);
2. U.S. application Ser. No. 13/440,834, filed Apr. 5, 2012, and entitled, “Social Network Device Communication Resource Allocation,” (Attorney Docket No. BP23771.1);
3. U.S. application Ser. No. 13/408,986, filed Feb. 29, 2012, and entitled, “Social Device Resource Management,” (Attorney Docket No. BP23776);
4. U.S. application Ser. No. 13/408,991, filed Feb. 29, 2012, and entitled, “Social Device Anonymity via Full, Content Only, and Functionality Access Views,” (Attorney Docket No. BP23776.1);
5. U.S. application Ser. No. 13/337,495, filed Dec. 27, 2011, and entitled, “Advanced Content Hosting,” (Attorney Docket No. BP23823);
6. U.S. application Ser. No. 13/351,822, filed Jan. 17, 2012, and entitled, “Ad Hoc Social Networking,” (Attorney Docket No. BP23785);
7. U.S. application Ser. No. 13/436,557, filed Mar. 30, 2012, and entitled, “Social Networking Grouping Hierarchy,” (Attorney Docket No. BP23785.1); and
8. U.S. application Ser. No. 13/485,856, filed May 31, 2012, and entitled, “Management of Social Device Interaction with Social Network Infrastructure,” (Attorney Docket No. BP23785.2).

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

1. Field of the Invention

The invention relates generally to social networking; and, more particularly, it relates to social resource management, allocation and arbitration.

2. Related Art

The popularity and growth of social network sites and services has increased dramatically over the last few years. Existing social network sites include Facebook, Google+, Twitter, MySpace, YouTube, LinkedIn, Flicker, Jaiku, MYUBO, Bebo and the like. Such social networking sites are typically organized around user profiles and/or collections of content.

In many popular social networks, especially profile-focused social networks, activity centers on web pages or social spaces that enable members to view profiles, communicate and share activities, interests, opinions, status updates, audio/video content, etc., across networks of contacts. Social networking services might also allow members to track certain activities of other members of the social network, collaborate, locate and connect with existing friends, former acquaintances and colleagues, and establish new connections with other members.

Individual members typically connect to social networking services through existing web-based platforms via a computing device, tablet or smartphone. Members often share a common bond, social status, or geographic or cultural connection with their respective contacts. Smartphone and games-based mobile social networking services are examples of rapidly developing areas.

In so-called “cloud” computing, computing tasks are performed on remote computers/servers which are typically accessed via Internet connections. One benefit of cloud computing is that may reduce the relative processing and storage capabilities required by user devices (e.g., a cloud computer may load a webpage accessed by a tablet device and communicate only required information back to the tablet). Accordingly, recent years have witnessed an ever-growing amount of content and application software being migrated from local or on-site storage to cloud-based data storage and management. Such software functionality/services and content are typically available on-demand via (virtualized) network infrastructures. In traditional social networks, interactions involving various applications and services often employ simplistic, location or regional-based approaches.

### BRIEF DESCRIPTION OF THE DRAWINGS

FIG. 1 illustrates a schematic block diagram of a social networking environment according to various embodiments of the disclosure;

FIG. 2 illustrates a schematic block diagram of a social networking environment according to various embodiments of the disclosure;

FIG. 3 illustrates a schematic block diagram of a social networking environment according to various embodiments of the disclosure;

FIG. 4 illustrates a schematic block diagram of a social networking environment according to various embodiments of the disclosure;

FIG. 5 illustrates an embodiment of a network according to various embodiments of the disclosure;

FIG. 6 illustrates a flow diagram according to various embodiments of the disclosure;

FIG. 7 illustrates a flow diagram according to various embodiments of the disclosure;

FIG. 8 illustrates a flow diagram according to various embodiments of the disclosure;

FIG. 9 illustrates a schematic block diagram of a social networking environment according to various embodiments of the disclosure;

FIG. 10 illustrates a schematic block diagram of a social networking environment according to various embodiments of the disclosure;

FIG. 11 illustrates a schematic block diagram of a social device according to various embodiments of the disclosure; and

FIG. 12 illustrates a schematic block diagram of a social device according to various embodiments of the disclosure.

### DETAILED DESCRIPTION OF THE INVENTION

As used herein, the terms “social network” and “SNET” comprise a grouping or social structure of devices and/or individuals, as well as connections, links and interdependencies between such devices and/or individuals. Members or actors (including devices) within or affiliated with a SNET may be referred to herein as “nodes”, “social devices”, “SNET members”, “SNET devices”, “user devices” and/or “modules”. In addition, the terms “SNET circle”, “SNET group” and “SNET sub-circle” generally denote a SNET that comprises SNET devices and, as contextually appropriate, human SNET members and personal area networks (“PANs”).

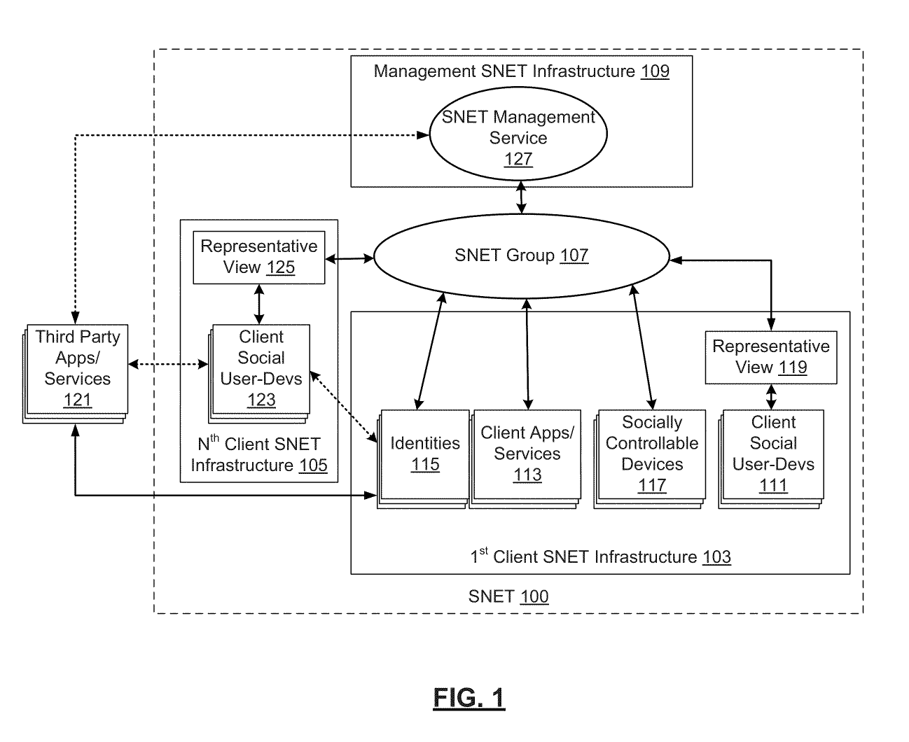

Referring to FIG. 1, a social networking (hereinafter “SNET”) environment according to various embodiments is illustrated and discussed. In some embodiments, various elements associated with a SNET environment can support specialized member access functionality associated with various SNET members. Such functionality can be associated with various devices, applications, information, resources, and the like associated with one or more SNET members, which can include members of one or more SNET groups.

In some embodiments, a member can manage various resources through a SNET management service. The SNET management service can be a part of a management SNET infrastructure supporting as least part of interactions involving a SNET group. The SNET management service can also be a service that is docked as a member of the SNET group. The SNET management service can be part of a SNET management system.

In some embodiments, a SNET group member can, via a docking process, dock one or more various elements to the SNET group. As shown in the illustrated embodiment, various elements associated with a first client SNET infrastructure 103 in SNET 100 can be docked with SNET group 107. Elements associated with the first client SNET infrastructure 103 can include, without limitation, resources including various social user-devices 111, socially controllable devices 117, applications and services 113 associated with the first client SNET infrastructure, identities 115, and the like. In some embodiments, identities can include an identity, ID handle, or the like associated with various applications and services, including third-party applications and services 121. Such identities can include accounts, profiles, and the like associated with various applications and services. A SNET group member can interact with various aspects of the SNET group via the docked device including, without limitation, various applications and services provided to some or all members of the SNET group, information associated with other SNET group members, other SNET group members themselves, other devices docked to the SNET group, and the like. A SNET group member can interact with various aspects of a SNET group via a representative view associated with the SNET group that can be provided to the SNET group member via an interface on a device. In the illustrated embodiment, for example, a member associated with the first client SNET infrastructure 103 can interact with various aspects of SNET group 107, including various docked elements via a representative view 119 presented via a social user-device 111. In another example, a member associated with an Nth Client SNET infrastructure 105 can interact with various docked elements of SNET group 107 via a representative view 125 presented via one or more user-devices 123 associated with infrastructure 105. For example, where a SNET group member docks a device 123 including a user interface, such as a computer, to a SNET group 107, the SNET group member may interact with various applications and services 113 docked with the SNET group 107 via a representative view 125 of the SNET group presented to the SNET group member via the computer user interface. The representative view can include representations of various aspects of the SNET group including, without limitation, applications and services docked to the SNET group; the SNET group member can access such aspects by interacting with the representations via the user interface.

In some embodiments, a SNET management service 127 can support specialized member access functionality in a SNET environment. Such functionality can enable a member to utilize a device docked to a SNET group to manage functionality including, without limitation, various applications, services, information, or the like. In some embodiments, a member can manage specialized member access functionality via interaction with the SNET management service through an interface in a docked device. The interface can comprise a set of functionality associated with various elements docked to one or more SNET groups. In some embodiments, the interface can comprise a common interface through which a member can manage all elements associated with a SNET group including, without limitation, devices, software, applications, services, information, accounts, access by various members, some combination thereof, or the like.

In some embodiments, a SNET management service can be docked to a SNET group as a member. For example, in the illustrated embodiment, SNET management service 127 is associated with a Management SNET infrastructure 109 and is docked to SNET group 107. In some embodiments, the SNET management service can be included in one or more processing systems associated with a SNET group and can support some or all of the access functionality associated with the SNET group. For example, in the illustrated embodiment, SNET management service can be an application or service 113 associated with infrastructure 103, a module included in a docked user-device 111, some combination thereof, or the like, and can manage some or all of the access functionality associated with SNET group 107. In another example, SNET management service can be part of a central SNET management infrastructure 109 that supports access functionality associated with various SNET groups in SNET 100, including SNET group 107. SNET group 107 can be part of Management SNET infrastructure 109, which can manage interactions with various other client infrastructures.

In some embodiments, specialized member access functionality includes docking and managing various resources associated with a SNET member infrastructure. Resources can include, without limitation, applications and services associated with a member supported by the SNET member infrastructure, member identities associated with various applications and services, information associated with various members, access logic associated with various members, applications and services, and the like. Identities can include identities, ID handles, accounts, profiles, and the like associated with third-party applications, services, and devices 121, and may further include communication system addresses, communication system accounts, application accounts, profiles, and the like. Applications and services can include communication systems including, without limitation, various communication programs, e-mail systems SMS messaging systems, telephonic communication systems, and the like.

In some embodiments, specialized member access functionality involves managing communication involving various members of a SNET. A SNET management service can manage access and control involving various resources docked to the SNET group. In one example, communications involving one or more members of a SNET can be managed using desired resources. Where a member has docked an identity, ID handle, or the like 115 associated with a third-party communication system 121, such as a SIM card, smart card, secure RFID device, an e-mail account associated with an e-mail communication system, or the like, the SNET management service can manage access and control of communications between the member and other members of a common SNET group 107 via such identity.

The communication management can be transparent to other SNET members. For example, in the illustrated embodiment, members associated with infrastructure 105 can send a text message to another member via interaction with the SNET group 107, but the SNET management service 127 can support routing the text message to be received by a member of infrastructure 103 via a docked email account 115 of a third-party email system 121, where other SNET members of infrastructure 105 sending text communications to the member are unaware that the text message is received via the email account. In another example, a SNET group member associated with infrastructure 103 can dock an account 115 of a third-party audio communication system 121, such as Skype, to a SNET group 107, and a SNET management service 127 can support routing some or all audio communications by other members associated with infrastructure 105 to the member associated with infrastructure 103 as Skype calls to the docked Skype account. Outgoing calls from the member via the docked Skype account can be presented to the other SNET group members associated with infrastructure 105 as a communication via some part of a common SNET communication system, a communication from the member's SNET account, or the like. Interactions between members using docked resources can be managed via the SNET management service based upon member input, internal logic, or the like.

In some embodiments, various applications and services 113 can be docked to a SNET group 107 and managed, in part or in full, via a SNET management service 127. Such docking can proceed as part of a docking of a device 111 associated with the applications and services 113, independently thereof, or the like. For example, an application 113 can include an alarm application that presents a wake-up message to a user via one or more devices 117; where the alarm application 113 is docked to a SNET group 107, the SNET management service 127 can enable other members of the SNET group 107 to interact with the alarm application 113 via interaction with a representative view 125 of some or all of the SNET group 107, or the like.

In another example, a communication priority application 113 can be docked with a SNET group 107 and managed by a SNET management service 127 to prioritize communications between one or more SNET group members. Communications received from various SNET group members, presented via one or more communication systems, applications, services, and the like, can be presented to a member as a list, schedule, or the like ordered by a priority of participants of the communication, based upon various relationships with the respective SNET group members. For example, messages from certain family members may be presented at the head of a list of communications, followed by co-workers, friends, etc. The list of communications can be presented as a schedule of communications to which a member is to respond, and may be updated based upon various interactions, communications, and the like involving one or more members. A list can be generated while a SNET member is engaged in other ongoing communications, such as a voice-call, and presented via a user interface once the ongoing communications are complete. The list can also be available for interaction at any time and updated as new information and interactions are identified by the SNET management service.

In some embodiments, a SNET management service can interrupt ongoing communications with an indication of another communication based upon a priority associated with a participant of the other communication. Such interruption can be part of a caller-identification functionality associated with one or more applications, identities, etc. For example, the SNET management service 127 may send an interrupt indication, during an ongoing voice call, to inform a participating member of another voice call from a certain family member, where the certain family member is associated with a high priority, and the SNET management service 127 may refrain from sending such an indication where the other voice call is from a lower-priority member. In some embodiments, the SNET management service 127 can provide one or more various functionalities for certain communications involving a SNET group 107 including, without limitation, call-waiting functionality, caller-identification functionality, etc. For example, communications to a certain SNET group member that are put on “hold” can be prioritized based upon a prioritization of the senders of the various communications. Prioritization can be based upon input from a SNET member, internal logic, or the like.

In some embodiments, a SNET management service can prioritize interactions involving and SNET member based upon the type of communications. For example, the SNET management service can present a SNET member with a schedule of communications to which the member is to respond, where the communications are ordered by type. The priority of various types of communications can be determined based upon member input, internal logic, or the like. For example, voice calls and messages can receive the highest priority, with emails, text messages, and the like having a lesser priority, such that the SNET member is presented with a list of communications that prompts the SNET member to respond to various voice calls before responding to various text messages.

In some embodiments, a list of communications can be presented to a SNET member in portions, where the presented portions are updated continuously, intermittently, based upon interactions, or the like. For example, a list may be presented, via a user interface on a device, as one or more representations of a single communication to which the SNET member is prompted to respond. The representations can include contact information associated with one or more participants of the communication, a message, a timestamp associated with the communication, and the like. Upon the SNET member taking some action regarding the communication, including responding to the communication, dismissing the communication, or the like, the list can be updated to present another one or more communication representations in an order of priority.

In some embodiments, a SNET management service can manage scheduling functionality through various devices, applications, services, resources, and the like associated with a SNET group. For example, an application that includes a schedule of various operations can be docked to a SNET group and managed by a SNET management service based upon various information and interactions associated with other SNET group members, docked elements, and the like. The schedule of operations can be accessed by selected SNET group members, extended to various SNET group members, and the like based upon member input, internal logic, or the like.

In some embodiments, various elements docked to a SNET group can be managed, in part or in full, by a SNET management service based on various spatial dependencies. Elements can be managed such that the SNET management service responds to a proximity indication by providing an indication to one or more various associated members. In one example, where a schedule of operations associated with a SNET member infrastructure, account, or the like includes a list of operations associated with various physical locations, such as a shopping list, the SNET management service can respond to determining that a device associated with one or more selected SNET member infrastructures is in proximity to an associated location, such as a grocery store, by sending a signal to the associated device. The signal can include an indication, such as a reminder of a portion of the list of operations relevant to the proximate location, an indication of the physical location, or the like. Indications can include a context, a message, a display associated with an application or service, some combination thereof, or the like.

In another example, where an application associated with a first member infrastructure is a communication system that includes one or more communication logs associated with various SNET members, and a device associated with the first member infrastructure is determined by the SNET management service to be in a certain physical proximity to device associated with a second member infrastructure, the SNET management service can respond by presenting a part of a recent communication log involving members of the first and second member infrastructures via one or more devices. In this way, a member of the first member infrastructure, upon coming into proximity of another member of the second member infrastructure, may receive, at a user interface of a device supporting the member, one or more communications that the member had with the other member.

In some embodiments, a SNET management service can extend interactions involving various applications to multiple SNET members. For example, where a first member infrastructure is associated with a shopping list application, and the first member infrastructure is associated with a second member infrastructure, the SNET management service can extend access to the shopping list application to a member associated with the second member infrastructure. The SNET management service can also respond to determining that a device associated with the second member infrastructure is in proximity (also referred to herein as spatial proximity) to a location associated with some or all of the shopping list application by sending a relevant, up-to-date portion of the shopping list application to be displayed on a user interface included in the device. In another example, the SNET management service can respond to determining that a device associated with the second member infrastructure is in proximity to a location associated with some or all of the shopping list application by sending a signal, including an indication of the proximity of the device, to the location to a device associated with the first member infrastructure and enabling some part of the first member infrastructure to respond to the indication by sending a signal related, at least in part, to the shopping list application, back to the device associated with the second member infrastructure.

In another example, a SNET management service can support spatially-based interactions between various SNET group members. The SNET management service can be associated with one or more information repositories, such as a tracking module, that maintains information related to a SNET group member's generally location, a location associated with a docked device, or the like. Locations can be determined based upon member input, GPS data received from a docked device, server devices supporting a SNET group member, or the like. The SNET management service can process the various respective locations associated with various SNET group members, devices, and the like to extend specialized interaction options to SNET group members. For example, a central SNET management service can respond to a SNET group member's desire to perform certain location-based operations that can include, without limitation, going to a restaurant with a group of friends or carpooling to various locations by extending to the SNET group member a list of proximate SNET group members with whom the SNET group member can interact in furtherance of performing the desired operation. Such a list can be generated based upon information in a repository including, without limitation, location information associated with a SNET member, member preferences for performing certain operations, visibility to other proximate members, and the like.

In some embodiments, access to various elements docked to a SNET group can be distributed across various devices docked to the SNET group. For example, access to an application, service, or identity associated with a first SNET member infrastructure and/or account can be selectively restricted to certain members, devices, applications, and services docked or otherwise associated with the SNET group. In some embodiments, a SNET group can be established to extend access to a certain element to various SNET members. For example, where a scheduling application is associated with a first SNET member infrastructure, a SNET management service can establish a SNET group and dock the scheduling application and various other devices, members, and the like to the SNET group to extend access to the scheduling application. Access can be managed based upon input from various members, applications, services, some internal logic, some combination thereof, or the like. In some embodiments, a SNET management service can manage access to identities docked to a SNET group by various entities. A SNET management service can permit another SNET member, a third party, or the like to access an identity, which can include a secure element, and use the identity to perform various actions, based upon input from a member, some internal logic, or the like. For example, based upon user input, a SNET management service may extend access to a SNET group member's stock-trading service account, which can include a monetary source ID, to a stock broker, which can be a SNET group member or a third party. The stock broker can then perform actions using the identity, such as purchase stocks using the account. Such extensions of access to identities can be temporary, restricted, or the like. For example, a stock broker can be extended access to a stock trading service account for a period of time, but only for as long as transactions performed by the broker do not exceed certain restrictions.

In some embodiments, various interactions in a SNET environment can be managed according to certain interactions and information. The SNET management service can restrict visibility of, or access to, one or more docked elements associated with one or more SNET members, member infrastructures, or the like based upon various interactions and information associated with the SNET member. For example, where a SNET member desires to seek out a certain product, the SNET management service can allow various communications from services associated with the product to be received by the SNET member via one or more communication applications that can be part of or docked to a SNET group, associated with an identity docked to the SNET group, etc. Where information associated with the SNET member indicates that the SNET member may no longer desire interactions with the above services, such as after the SNET member purchases the product or otherwise ceases seeking out the services, the SNET management service can restrict access to the SNET member by the services. Such restrictions can include labeling messages involving the services as spam, automatically deleting incoming messages involving the services, and/or presenting the SNET member as busy, offline, invisible, or the like with regard to the services on the SNET. Such restrictions can involve ranking various SNET members to determine whether to restrict interactions involving the SNET members, establishing a firewall block that can be selectively modified by a SNET member to allow certain communications that would otherwise be blocked, etc.

In some embodiments, device servicing and support is accomplished through an automatic group association process. The process may comprise, for example, automatically offering (upon docking of a device to a user account in a SNET) device registration, service support, user-to-user interaction, updates, etc., via the SNET. Currently, such services and activities are typically performed manually, without a common infrastructure, and therefore may not occur in a timely manner, if at all.

In some embodiments, upon activating or docking a device to a SNET group, the user's account information is automatically (or via a setup-up prompt) provided to the SNET group in a SNET environment. The device can receive an offer to auto-join the SNET group, such as a manufacturer's SNET group specific to a particular device model. Acceptance of the offer can involve adding the device as a member to one or more of operator's/manufacturer's associated SNET groups to provide, for example: (i) access to registration/warranty/rebate information and extended warranty offers; (ii) testing, update, and service offerings; (iii) usage tutorials and user group interactions; (iv) periodic testing, configuration analysis, and ad hoc updates and upgrades; (v) targeted advertising; (vi) tracking of in-service devices; (vii) detection of service problems, and the like. Certain SNET groups can similarly include offerings such as rebate information, coupons, forums, Twitter, Skype and/or other social media capabilities, etc.

Devices can be configured, manually or through factory-staged settings and security, to delegate membership control to a social network/circle. In some embodiments, devices docked to a SNET group can be monitored through the SNET group. For example, where a device is docked to a manufacturer's warranty-related SNET group, the SNET management service can support monitoring of various aspects of the device, including, without limitation, device properties, performance information, maintenance data, and the like, via a shim layer, shim properties, performance information, maintenance data, etc. Depending on device capabilities, such monitoring might involve a shim layer, shim driver, etc.

In some embodiments, devices can be un-docked from a SNET group based upon various internal logic associated with a SNET group. For example, where a manufacturer's associated SNET group provides testing, update, and service offerings to devices for a period of time related to a device warranty, devices may be allowed to be docked to the SNET group for the period of the warranty, and then un-docked from the SNET group upon lapse of the warranty. In some embodiments, undocking of a docked element is anonymous, such that a member supported by the element is not alerted that the element is un-docked. For example, a member supported by a device docked to a manufacturer's warranty-related SNET group may not be alerted if the device is un-docked from the SNET group upon lapse of the device's warranty.

In another example, a user can rely on other SNET members/friends or a service network to assist with the aforementioned device setup and servicing. Relevant SNET groups can comprise a trouble-shooting SNET group, IT support SNET group (providing, e.g., data backup or application installation support), theme support SNET group, advertising SNET group, storage management SNET group, monitoring SNET group (e.g., a baby monitor device accessible by family members or caregivers), etc. A user's profile information and access capabilities/views may be visible to such SNET group.

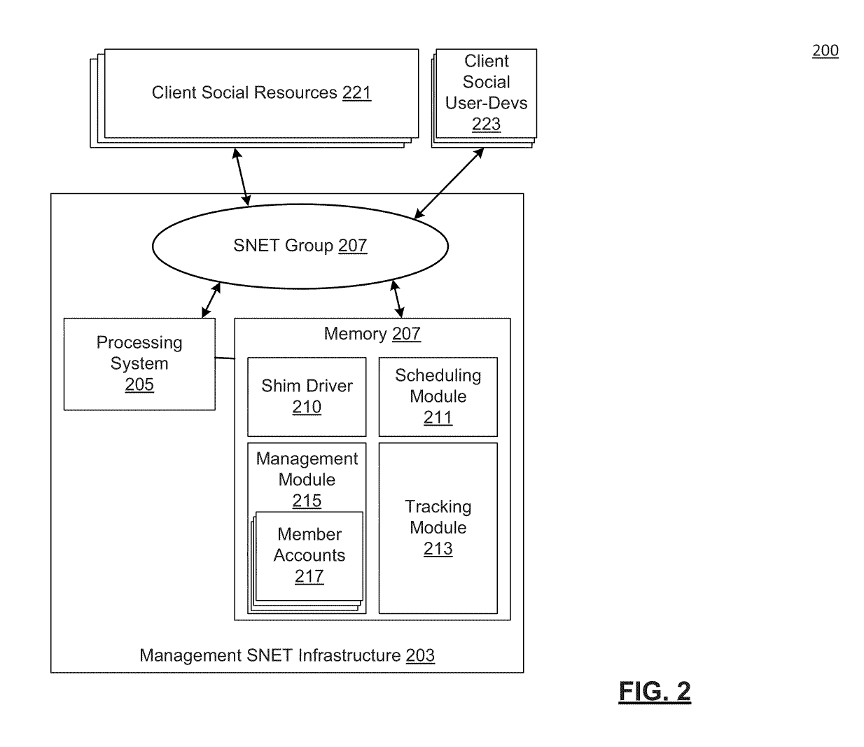

Referring now to FIG. 2, a SNET environment 200 according to various embodiments is illustrated. In some embodiments, various access functionalities associated with a SNET group 207 can be supported, managed, and the like by a SNET management service that is associated with a SNET management infrastructure 203. The SNET management infrastructure 203 can include a processing system 205, memory 207, and the like which interoperate to support various access functionalities. For example, as shown in the illustrated embodiment, where various client social user-devices 223, client social resources 221, and the like are docked to SNET group 207, the processing system 205 and memory 207 in SNET management infrastructure 203 can interoperate to support access to and control of the various devices 223 and resources 221. Docked resources 221 can include applications, services, identities, and the like associated with various SNET members, client infrastructures, and the like associated with the SNET group 207.

In some embodiments, a memory 207 included in a SNET management infrastructure can include various modules and drivers utilized to support various access functionalities. For example, as shown in the illustrated embodiment, memory 207 can include a scheduling module 211 utilized to support docked applications that involve scheduling lists. The scheduling module 211 can be used to maintain scheduling lists, generate indications to be presented to various users supported by various devices 223 via user interfaces, generate representations of lists to be presented to various users, and the like. In one example, the scheduling module can generate a list of communications to which a user supported by a device 223 is to respond, where the list is prioritized based upon factors including, without limitation, communication medium and participants in the communication.

In some embodiments, memory 207 includes a tracking module 213 that supports access to and control of various resources and devices based upon the relative spatial locations of various devices 223 docked to SNET group 207. For example, tracking module 213 can be used to determine when various devices 223 docked to SNET group 207 are within a certain proximity. The tracking module 213 can be used to respond to such a determination by sending indications to one or more of the devices 223, extending access to various docked elements to one or more of the proximate devices, including one or more resources 221, access or control of one or more devices 223, or the like. In some embodiments, memory 207 can include a management module 215 that includes various accounts 217 associated with various members of SNET group 207. Each account 217 can include various access rules/permissions for devices and resources associated with various members. For example, an account 217 can include access rules that reserve access to certain social resources 221 to a subset of SNET group members, including, without limitation, family members, friends, co-workers, SNET group members within a certain proximity of a device 223 associated with the particular SNET group member, etc.

In some embodiments, SNET management infrastructure 203 can be part of a central SNET management system that supports specialized member access functionality associated with some or all of a SNET environment 200. For example, SNET management infrastructure 203 may support establishment of SNET group 207 and docking of resources 221 and devices 223 based upon interactions between various SNET members, some internal logic, or the like. In some embodiments, SNET groups can be established by the SNET management infrastructure 203 on an ad hoc basis and can be semi-permanent and/or temporary. For example, where an application 221 is associated with a SNET member infrastructure, SNET management infrastructure 203 can support establishment of a temporary SNET group 207 to which the application 221 and additional members/devices are docked to extend access to the application based upon input from a SNET member infrastructure, internal logic, or the like. Memory 207 can also include a shim driver 210 that enables communications between the SNET management infrastructure and various social devices 223 docked to SNET group 207, SNET infrastructure 203, one or more processing systems, and/or SNET members and other compatible devices, including social devices that may not fully support a SNET group communication protocol. The shim driver can, in some embodiments, be installed in one or more docked devices 223 through a SNET node or local storage, or downloaded from a manufacturer website or cloud-based resource. Such installation may occur automatically upon power up or activation of some or all of the social device 223/infrastructure 203, as directed by the infrastructure 203, other infrastructures, devices, or the like.

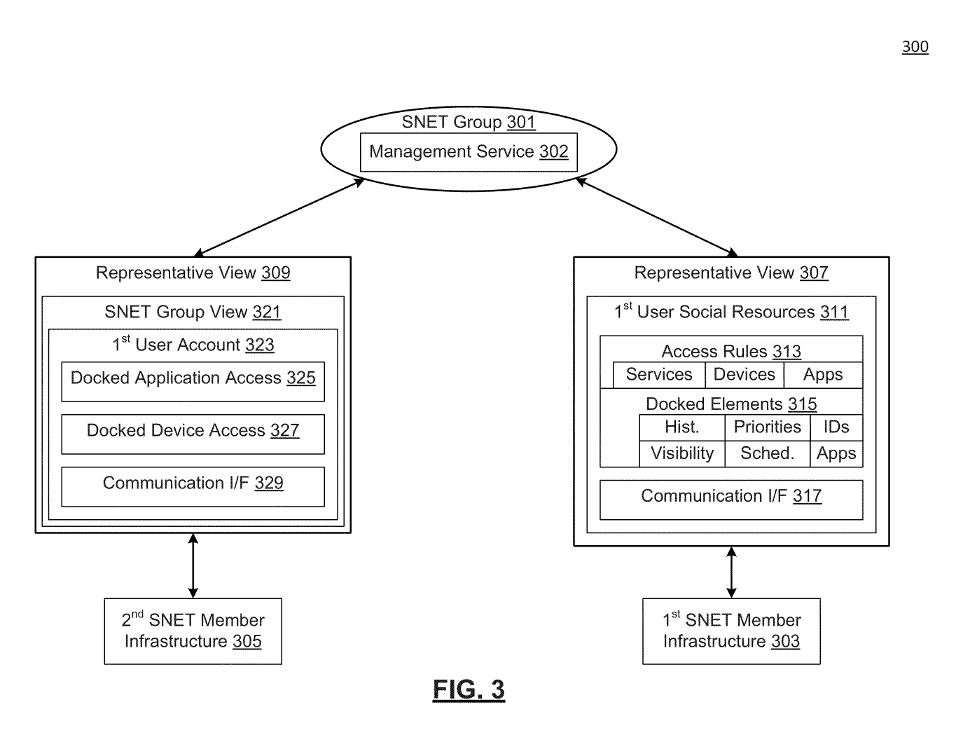

Referring now to FIG. 3, a SNET environment 300 according to various embodiments is illustrated and discussed. In some embodiments, a SNET management service can support interactions by a SNET member with various aspects of a SNET group via a representative view. A representative view can include representations of various aspects of a SNET group including, without limitation, various docked devices, applications, services, other resources, and SNET group members with which a member can interact via the representative view.

For example, as shown in the illustrated embodiment, SNET management service 302 can support providing a representative view 309 associated with SNET group 301 to an infrastructure 305 associated with at least one member of the SNET group 301. The representative view 309 can include a representation 321 of the SNET group 301, which itself can include a representation of access functionality associated with other members of the SNET group. For example, representation 321 of the SNET group 301 can include a representation 323 that includes all resources of an infrastructure 303 associated with another member of SNET group 301 that can be accessed by a member of infrastructure 305. The accessible resources can be presented as representations that a member can interact with to access the resources. For example, as shown in the illustrated embodiment, a member associated with infrastructure 305 can interact with a representation 325 of various applications and services associated with infrastructure 303 that are docked to SNET group 301 and are accessible to a member of infrastructure 305.

Similarly, a member associated with infrastructure 305 can interact with a representation 327 of various devices associated with infrastructure 303 that are docked to SNET group 301 and are accessible to a member of infrastructure 305. Such devices can include, without limitation, printers, computers, electronic devices, and other devices that can be socially controlled. In addition, as shown in the illustrated embodiment, a member can interact with a communication interface 329 to communicate with various members. In the illustrated embodiment, communication interface 329 can be used to communicate with one or more selected members associated with infrastructure 303. Communications can be routed between infrastructures using various separate communication systems. For example, where infrastructure 303 includes an identity, such as an email account, associated with a third-party email system that is docked to SNET group 301, communications sent to a member of infrastructure 303 from a member of infrastructure 305 via interface 329 can be received by the member of infrastructure 303 as an email message at the docked email account, without the member of infrastructure 305 being aware of the routing of the communications.

In another example, as shown in the illustrated embodiment, SNET management service 302 can support provision of a representative view 307 associated with SNET group 301 to an infrastructure 303 associated with at least one member of the SNET group 301. The representative view 307 can include a representation 311 of various resources associated with infrastructure 303 that can be managed via interaction with the representative view 307. For example, a user associated with infrastructure 303 can interact with representative view 307 to manage various properties, rules, permissions, and other aspects associated with various elements associated with infrastructure 303 that are docked to SNET group 301. In addition, a user associated with infrastructure 303 can interact with representative view 307 to access various docked elements associated with other members of the SNET group 301.

In some embodiments, representation 311 can include a representation 315 indicating various applications, services, devices, identities, and the like that are associated with a SNET infrastructure, docked to a SNET group, or the like. For example, in the illustrated embodiment, representation 315 indicates various identities applications, and services that can be docked to SNET group 301. A user can interact with representation 315 to manage various aspects of the docked elements. For example, in the illustrated embodiment, representation 315 can include a representation of a scheduling application, which a user can interact with to develop and modify scheduling operations, such as shopping lists, communication lists, and the like. In another example, representation 315 can include a representation of a priority application, which a user can interact with to prioritize communications involving certain communication types, participants, and the like. In some embodiments, a representation of social resources 311 can include a representation of access rules associated with various applications, services, devices, and the like that are docked to the SNET group. For example, as shown in the illustrated embodiment, representation 313 can include indicators of access rules associated with various applications, services, and devices associated with infrastructure 303 that are docked to SNET group 301. In addition, as shown in the illustrated embodiment, a member can interact with a communication interface 317 to communicate with various other members. In the illustrated embodiment, communication interface 317 can be used to communicate with one or more selected members associated with infrastructure 305. Communications can be routed between infrastructures using various separate communication systems, as discussed above.

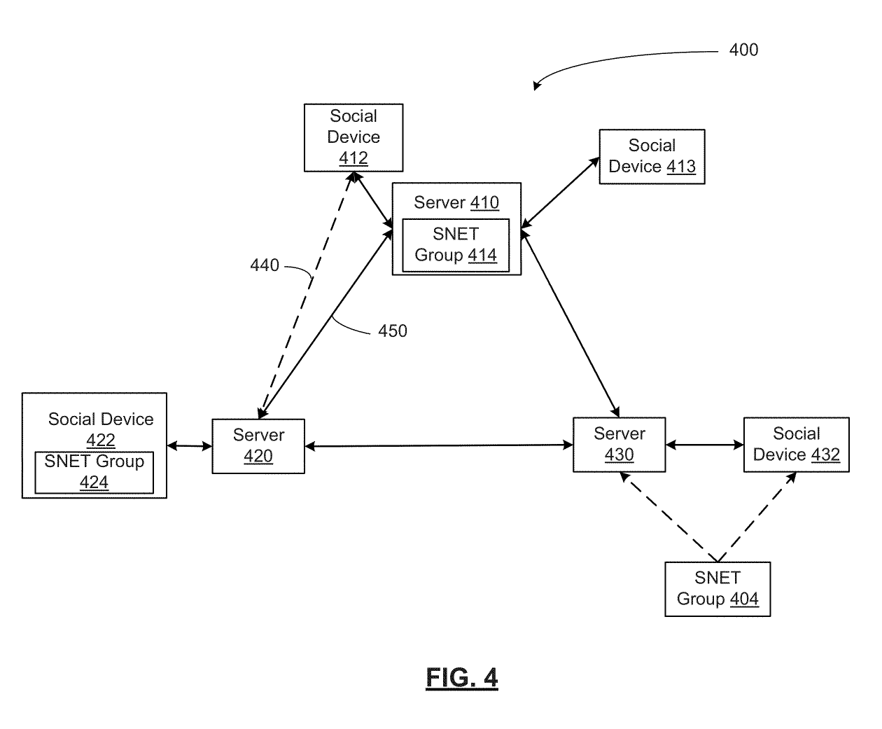

FIG. 4 illustrates an embodiment of a network 400 that utilizes dynamic load balancing. The illustrated embodiment of network 400 includes servers 410, 420, and 430, which can manage some or all of interactions between various social devices 414, 413, 422, and 432, various SNET groups 414, 424, and 404, and the like. Social devices in network 400 may be able to link directly (440) with any server or social device in network 400, indirectly via routing (450) through a server, or the like. Each server 410, 420, and 430 in network 400 may have access to information about the other one or more servers, social devices, and SNET groups in the network. For example, server 430 may be able to access information associated with social device 412 including, without limitation, the rate of downloads of content on network 400 or other networks, the most likely network access schedule of social device 412, the most likely social devices with which social device 412 may try to link in a SNET via interaction with a common docked SNET group, the SNET groups social device 412 is docked with, etc.

As shown in the illustrated embodiment, a server 430 can support at least some aspects of SNET group 404, which can be docked with a social device 432 that supports other aspects of SNET group 404. Based upon indications of network traffic, user preferences, properties associated with docked elements, SNET group members, or the like, various aspects of SNET group 404 can be supported by various parts of the network 400. For example, based upon location information, docked SNET groups, identities, and/or profile information associated with social devices 412, 413, 422 and 432, server 430 can determine that social devices 412 and 413 will most likely interact with aspects of SNET group 414 more than any other social devices in network 400. As a result, SNET group 414 can be supported in full by server 410 which can, in some embodiments, be selected due to being the most geographically proximate server, the server with the most direct or fastest connection to social devices 412 and 413, or like considerations. Distributing support of SNET group 414 can reduce the amount of traffic between servers caused, for example, by social devices 412 and 413 attempting to interact with each other via SNET group 414. Determination of which servers are to support various aspects of a SNET group may be made by a social device, server, a plurality of servers, some combination thereof, or the like.

In some embodiments, some or all of a SNET group can be supported by a device including, without limitation, a social device docked to the SNET group. For example, server 430 can determine, based upon network traffic information or user/device account information, that a social device 422 docked to SNET group 424 can support SNET group 424. In an embodiment where a SNET group 424 is docked with social device 422 (or vice versa), it might be more efficient to support SNET group 424 through social device 422, rather than require social device 422 to link with server 410 to interact with SNET group 424. In addition, it might be more efficient to support SNET group 414 in full by server 410, rather than require social devices 412 and 413 to link, directly, indirectly, or the like, with server 420 to interact with SNET group 414.

In some embodiments, a SNET management service can extend limited or expanded access to various elements associated with a SNET member infrastructure that is docked to a SNET group. Limited access to elements associated with a member infrastructure can include access that is terminated upon an elapse of time, access based upon a physical proximity to a device associated with the SNET member infrastructure, or the like. In some embodiments, a SNET management system can manage interactions between various SNET members to expand access. For example, a SNET management service can manage interactions between some or all members of a SNET group such from one or more server devices, nodes, or the like, based upon a proximity or some other association between the members. For example, where members of a SNET group 414 are located in a common geographical area, aspects of the SNET group 414 including, without limitation, interactions between the SNET group members, can be managed by a single server device 410 associated with the common geographical area. The SNET management service can expand access, interactions, and the like between SNET members interacting from a common server. For example, voice calls between SNET members interacting via a single network node can be free of charge.

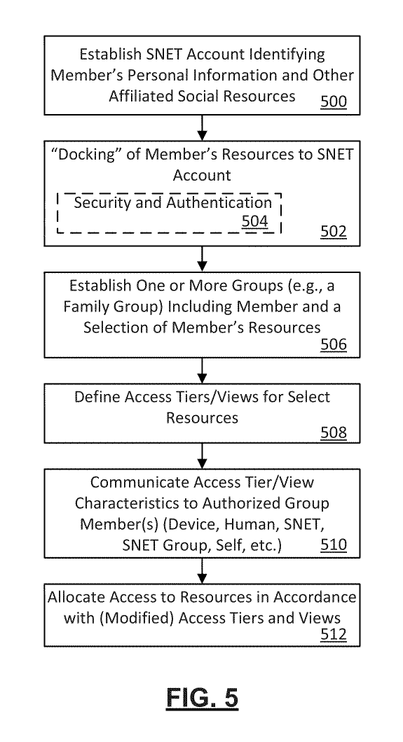

FIG. 5 is a logic diagram of an embodiment of a method for supporting specialized member access functionality in accordance with various embodiments. In an initial step 500, a SNET member establishes a SNET account that identifies the member's personal information and other associated social resources. Associated social resources can include various applications, services, and the like associated with the member and/or one or more various devices supporting the member. As noted above, personal information can include various identities, ID handles, application accounts, etc. Next, or contemporaneously, in step 502 the member's resources are “docked” (e.g., online, through near-field communications (NFC) coupling, or via networked operations) to the SNET account. Such docking may involve security and authentication operations 504 including, by way of example and without limitation, authentication/authorization operations utilizing unique biometric identifiers, passwords, token-based identification, trusted authorities or documents, gesture sequences, SIM cards, smart cards, RFID circuitry and/or other secure elements.

The method continues in step 506 with the creation of one or more SNET (sub)groups (e.g., a family group) including the member and a selection of the member's resources, resources and SNET circle members having related or specific characteristics and interdependencies, etc. In one embodiment, the member and/or social devices, personal information, other affiliated resources, some combination thereof, or the like may be added through a drag-and-drop user interface or other means. In step 508, access tiers and views are manually or automatically defined for select personal information, social device information, and other affiliated resources. This step may be conducted in whole or part by means of a (pop-up) table or form that requests tier settings and allows for personal tailoring of same. The member may select a particular group member (device or human or self) to reveal tier characteristics and allow modification of access rights. In some circumstances, selection of access rights may be based on profile data and other characteristics of a particular device, user or group seeking access to resources. Further, distinct access rights, including content and capabilities access views, may be assigned to different social device resources or groupings of resources, or to a particular request for access to social resources.

In step 510, access tier/view characteristics are communicated to authorized group members, which may include social devices (including the member's social devices), human members, a SNET or one or more SNET groups. Next, in step 512, resources are allocated in accordance with the access tiers and views communicated in step 510. Allocation of a resource may entail, for example, allocating the resource for dedicated use by a member of the SNET group, either on a persistent or temporary basis, subject to reallocation. Subsequent reallocation may occur, for example, if access to a previously allocated social device resource is requested by a second member (or non-member) having a higher priority or superior access rights to the resource. In certain embodiments of the disclosure, social resources may be dynamically offered and allocated if/when and to the extent such resources become available. Management of social resource reserves, including termination of related services, may be performed by individual devices, groupings of devices, and/or centralized or distributed SNET processing circuitry and software.

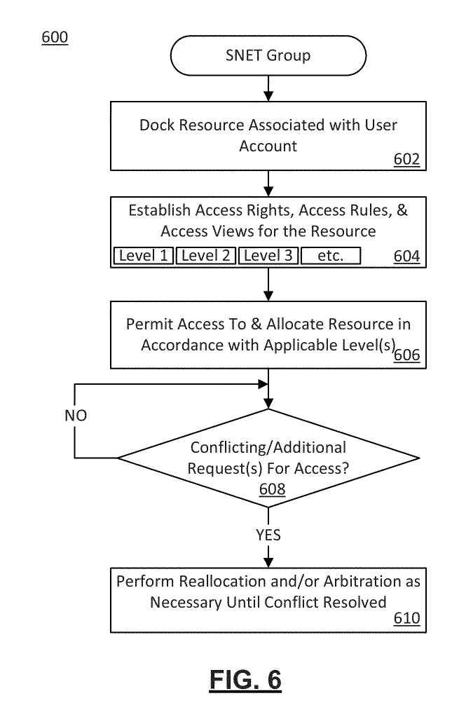

FIG. 6 is a logic diagram of an embodiment of a method 600 for establishing tiered views of and access to resources associated with a user account docked to a SNET group in accordance with various embodiments. First, the availability of a resource for access by members/non-members is determined via docking of the resource to a SNET group in step 602. Next, access rights, access rules, access views, and the like for the resource are established in step 604. Such access rights, rules, and views may provide for levels of access having varying degrees of granularity as contextually appropriate and as determined by one or more SNET nodes having control of the resource, or as determined by an authorized entity requesting access to the social resource.

Established levels of access rights are then applied to permit access to and allocation of the resource in step 606. If conflicting, modified or additional requests for access are identified in step 608, reallocation and/or arbitration is performed in step 610 as necessary to address conflicts or otherwise service such requests. In one embodiment wherein a particular device or user requires or requests a relatively large percentage of available resources, access may be denied or restricted, including on a temporary or persistent basis. Alternatively, other capable and available social resources may be employed to resolve such requests. Potential overuse or abusive use of a SNET resource may be detected by SNET monitoring functionality that employs static or dynamic thresholds.

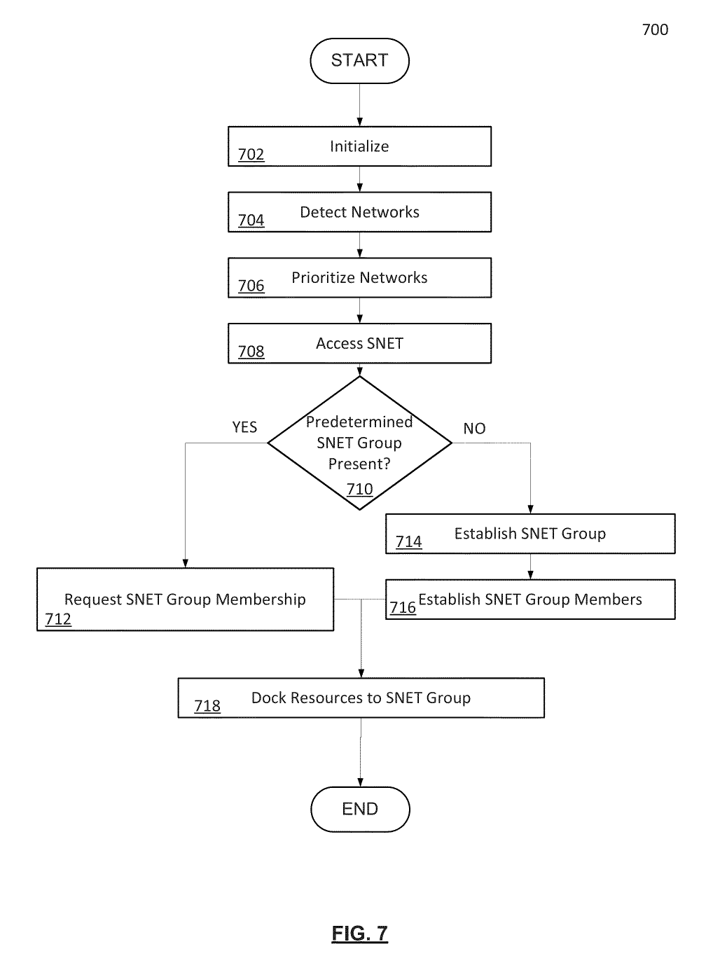

FIG. 7 illustrates a process 700 by which a device can interact with a SNET group to which it is docked directly, indirectly via another SNET group to which it is docked, some combination thereof, or the like. As shown in block 702, process 700 can include a device initializing. Initialization can include, without limitation, powering on or otherwise activating one or more functional elements. As shown in block 704, process 700 can include detecting one or more networks. The device, in some embodiments, can interact with various networks including, without limitation, a wired LAN, WLAN, cellular network, some combination thereof, or the like. Detection of networks can occur upon initialization of the device, continuously, intermittently, at predetermined intervals, some combination thereof, or the like. As shown in block 706, process 700 can include prioritizing detected networks, infrastructures, subgroups, etc. The device, having detected multiple networks, can prioritize which networks are to be utilized to interact with one or more SNETs, devices, some combination thereof, or the like. For example, a device can prioritize a WLAN network over a cellular network, such that the device will first attempt to use the WLAN to access one or more SNET groups or other devices; in the event of a power failure or some other interruption of service via the WLAN, the device can switch to another network, such as the cellular network, to maintain or reestablish a SNET communication. Prioritization of networks can be accomplished according to one or more rules, which can be stored by the device, received from a remote source, or the like. For example, a device can prioritize networks according to an internal rule; the rule can be replaced with an updated rule received by the device via a network connection. A rule upon which networks are prioritized can include, without limitation, connection speed, security, likelihood of connection interruptions, likelihood of connection failure, etc.

As shown in block 708, process 700 can include accessing one or more SNETs, SNET infrastructures, SNET groups, devices, some combination thereof, or the like. The accessing can be accomplished via one or more of the networks detected in block 704. The device can, in some embodiments, seek out certain SNETs according to predetermined information. For example, the device can have internally-stored information that identifies one or more specific SNETs that the device is to seek out, upon connecting with one or more networks, to join or establish a SNET associated with the device. Specified SNETs can be prioritized, such that the device will seek out certain SNETs before others according to one or more rules. The list of SNETs can be revised over time based upon the device's interaction with other devices, upon receipt of updates from a remote location, etc.

As shown in block 710, process 700 can include determining whether a located SNET includes a predetermined SNET group. The device can, in some embodiments, include information that identifies one or more predetermined SNET groups that the device is to seek out and join. Such a predetermined SNET group can include, without limitation, a SNET group for like devices, a SNET group for like devices within a certain geographic area, some combination thereof, or the like. Like devices can include, without limitation, devices associated with one or more similar aspects, functional elements, characteristics, properties, locations, devices related in some manner to a similar purpose, physical devices that can interact with a network, or the like. For example, a manufacturer of smoke detectors that can interact with a network may maintain a SNET group for some or all of its manufactured smoke detectors. The manufacturer may enable some or all of its smoke detectors to seek out and join its SNET group by providing the smoke detectors with information, including, without limitation, a Uniform Resource Locator (URL) address associated with the SNET, an identifier of the SNET group, some combination thereof, or the like. In another example, one or more SNET groups may serve various appliances that are physically located within various certain locations, which can include, without limitation, a kitchen, a certain room, a certain structure, a geographic location, some combination thereof, or the like. One or more of the appliances may have information that identifies a SNET group that the appliance is to seek out based upon the appliance's geographic location.

As shown in block 712, upon determining that a predetermined SNET group is found, the device can request membership in the predetermined SNET group. Membership can include docking the device with the SNET group, docking a SNET group to which the device is docked to the predetermined SNET group, etc. In some embodiments, the device can request the SNET to add the device as a member of the SNET group, request an existing member of the SNET group to accept the device as a member of the SNET group, and/or provide a password code for membership of the SNET group. A password code can be internally stored by the device, received from another device, some combination thereof, or the like.

As shown in blocks 714 and 716, process 700 can involve establishment of a SNET group by the device (or devices) itself. The establishment of a SNET group can occur in response, for example, to a determination that no predetermined SNET groups are present. For example, in some embodiments, the device does not know of any predetermined SNET groups and can create its own SNET group upon interacting with a SNET via a network connection. The device can request the SNET to create a SNET group, create the SNET group itself, some combination thereof, or the like, as shown in block 714, and can provide information related to the SNET group, such as a desired name for the SNET group, selected information to be accessible to one or more selected members of the SNET group, rules associated with interaction between members of the SNET group, some combination thereof, or the like. As shown in block 716, process 700 can include establishing members of the SNET group. In some embodiments, the device can request certain entities be added to the SNET group including, without limitation, another device associated with the device, a device supporting a member of the SNET, a device supporting a nonmember of the SNET, a member of the SNET, a nonmember of the SNET, some combination thereof, or the like. For example, a home security device establishing a SNET group for the device can request that a resident of the home in which the security device is located be added to the SNET, along with a local police service, local security service, some combination thereof, or the like. Where a nonmember is to be added as a member of the SNET group, the device can request the SNET to send an invitation to join the group to the nonmember, such that the nonmember can become a full member of the SNET group, a guest member of the SNET group, some combination thereof, or the like. Invitations to a SNET can be performed as discussed in U.S. Utility patent application Ser. No. 13/351,822, entitled “Ad Hoc Social Networking,” (Attorney Docket No. BP23785), filed Jan. 17, 2012, pending, which is hereby incorporated herein by reference in its entirety.

In either process shown in blocks 712 and 716, the device can establish docking specifications that govern interactions between the device and one or more SNET groups, members of the SNET group, or the like. For example, where the device is a security device that is being docked to a predetermined SNET group, the device can establish a docking specification that restricts access by some or all other members of the predetermined SNET group without prior authorization by a user of the security device, or the like. The docking specification may be created by the device, by the SNET group based upon inputs received by a user associated with the device, the SNET group based upon inputs received from another member of the SNET group, internal logic, some combination thereof, or the like.

As shown in block 718, process 700 can include docking various resources with the SNET group. The resources can be associated with a device that is docked to the SNET group. Resources can also be associated with an infrastructure to which the device is associated. For example, a resource can be an identity associated with a third-party application that is utilized to access the third-party application; the identity can be located in a memory local to a device. Upon docking the device to a SNET group, the identity can be docked automatically to the same SNET group. In another example, the identity can be docked to a SNET group based upon a request from a management service supporting some part of the SNET group, some internal logic in the device, or the like. A resource can be docked temporarily to a SNET group, such that the resource is docked or un-docked upon a trigger. For example, a resource can be docked or un-docked based upon spatial proximities associated with a device, an elapse of time, or the like.

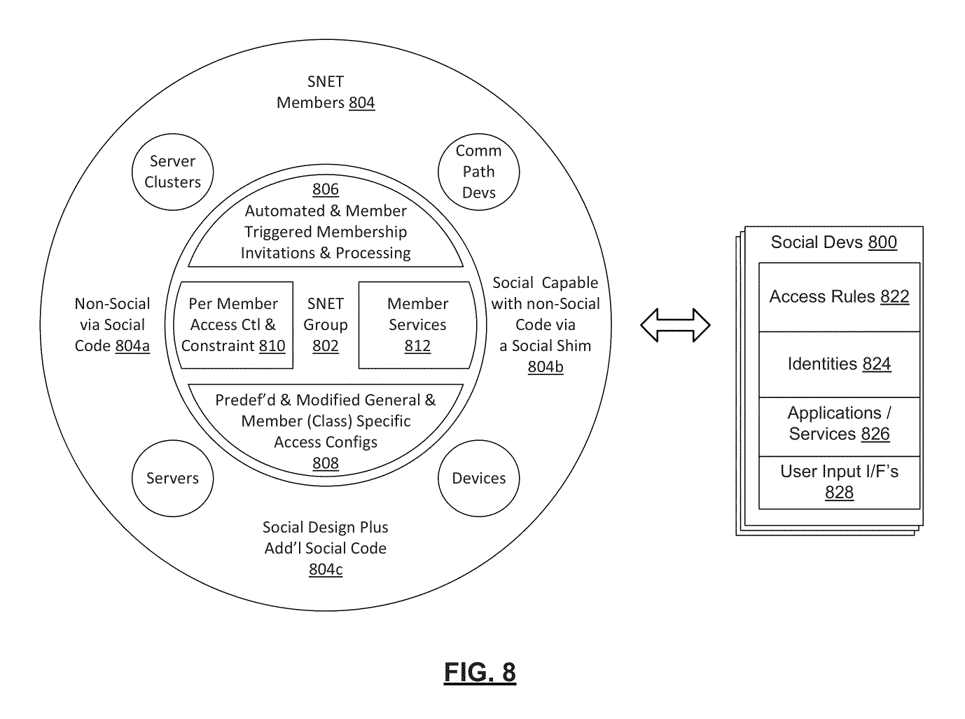

FIG. 8 illustrates an embodiment of a SNET group 802 comprising a variety of members in accordance with the present disclosure. In this embodiment, membership in the SNET group 802 includes a variety of novel SNET members 804 functioning in various capacities within the SNET group 802. As will be understood, certain of the SNET members 804 may support direct or indirect associations between the SNET group 802 and various social devices 800 docked to the SNET group 802.

In the illustrated embodiment, SNET members (or nodes) 804 include one or more local or remote servers and server clusters that provide a support infrastructure for SNET group functionality and member operations (routing, data storage, services, etc.). Communications within the SNET group and with non-members may occur via dedicated or multi-function communication path devices.

SNET members 804 further include devices configured to operate as nodes within the SNET group 802. Social functionality in such devices and other SNET members 804 can be implemented through various means. For example, a device may have integral hardware/firmware/software to support SNET group access and member operations. Alternatively, a general purpose device 804a may include social code that enables participation in the SNET group 802. In a further embodiment, a device 804b designed to include social functionality may participate in the SNET group 802 through a combination of non-social code and a social shim layer or driver wrapper. In yet another embodiment, a member device 804c having a social design may utilize additional social code, including code specific to a SNET group 802.

Participation in the SNET group 802 is supported through functionality that includes automated and member-triggered membership invitations and processing (membership management) 806. More particularly, membership management 806 may function to invite prospective members to participate in the SNET group 802 through automatic, automated and member-triggered processes. For example, membership management 806 might be configured by a human user 800 to establish a SNET group 802 by automatically inviting/accepting SNET members having certain characteristics (such as devices owned or controlled by the user or acquaintances of the user).

Processing of accepted invitations and unsolicited requests to join the SNET group 802 may be conditioned upon input or authorization from an existing SNET member(s) 804 or through a docked device 800 (e.g., through a user interface 828). Similarly, membership management 806 may be configured to generate automated suggestions regarding which prospective members receive an invitation. Various other approaches, such as those described herein, can be used to establish membership in accordance with the disclosure.

Access to and visibility of resources of a SNET group 802, including services and data, may be managed through general and member class-specific access configurations 808. For example, if membership in the SNET group 802 includes family members and associated devices, a uniform access configuration (or separate device and human configurations) could be applied across the class in an automatic or automated manner. In other embodiments, access control and constraints 810 are imposed on a per-member basis. Further details of access control and constraint in accordance with various embodiments of the invention are described below.

The SNET group 802 may offer a wide variety of member services 812, including both internal and external services accessible by SNET members 804. By way of example, the SNET group 802 may offer email or other communication services between full members and/or authorized guest members and visitors. As with other resources of the SNET group 802, access control and constraints on member services 812 may be applied to individual members or classes of members.

In some embodiments, a docked social device 800 includes various applications, services, identities, access rules, and the like that are docked with SNET group 802 based upon docking of the social device 800 to the SNET group. For example, as shown in the illustrated embodiment, social device 800 can include various access rules 822, identities 824, applications and services 826, and the like which can be located, in part or in full, in local memory. The above access rules can include rules governing access by various SNET members 804 to the various applications and services 826 located in social device 800. For example, an access rule 822 associated with a certain application 826 may restrict visibility of the application to only certain SNET members 804 interacting with SNET group 802. Access can be temporary, based upon an elapse of time, proximity of a device supporting a SNET member 804 to social device 800, or the like.

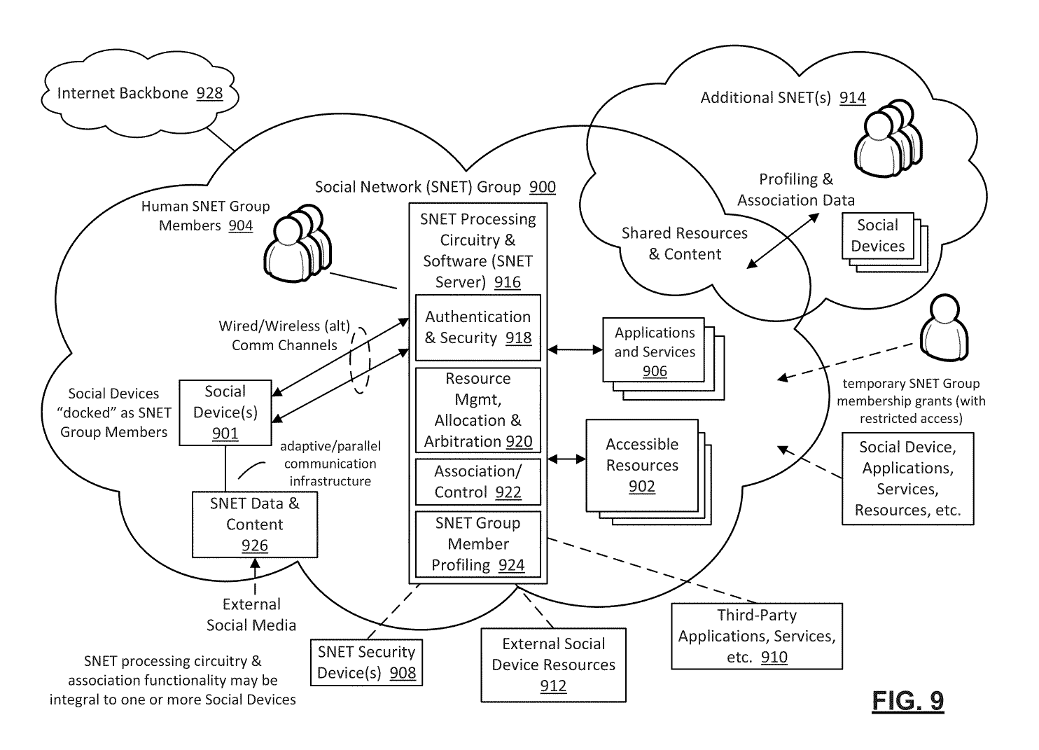

Referring now to FIG. 9, a social network circle/group 900 (hereinafter “social networking group”, “social networking circle”, “SNET circle”, “SNET group”, or the like) comprising social devices, accessible resources, applications and services, and the like is shown. Beyond traditional social networking features and services, a SNET group 900 and associated social devices 901, accessible resources 902, applications and services 906, and the like, according to various embodiments include numerous novel features and attributes as described more fully herein with general reference to the illustration.

Briefly, membership in the SNET group 900 may comprise docked social devices 901, applications and services 906, accessible resources 902, and the like. Social device 901 can include accessible resources 902, applications and services 906, and the like that are accessible to other members of the SNET group 900 and human SNET group members 904, as well as proxies thereof. Further, SNET group 900 nodes may include device services and software (e.g., applications) of various types participating as members. By way of example, SNET group members might include artificial intelligence agents/social robots 902 or 906, SNET security device(s) 908, third-party applications, services, service providers, and the like 910, common or authorized members/functionality of other SNET groups, resources, etc. 912. Further, access to specific content, applications, services, resources, and the like of a SNET group 900 may be shared with members of additional SNET(s) 914, including remote or web-based applications. Such access can be conditioned on acceptable profiling and association data. Similarly, social devices, applications, services, SNET groups, individuals, resources, or the like may be granted temporary or ad hoc memberships, with or without restricted access.

In the illustrated embodiment, formation, maintenance and operation of SNET group 900 is performed by one or more SNET processing systems and software 916. A processing system can include, without limitation, one or more instances of standalone SNET processing circuitry, one or more instances of distributed SNET processing circuitry located on one or more devices, social devices, server devices, network nodes, and the like. It is noted that the “SNET processing circuitry” may comprise hardware, software, applications, or various combinations thereof, and be configurable to support various functionalities disclosed herein. Further, the SNET processing system 916 may be included in a standalone server, server farm, cloud-based resources, and/or the various types of devices described below, and incorporate authentication and security functionality 918. In addition, specialized middleware may also be utilized by SNETs according to various embodiments, including standardized middleware (or standardized communication protocols) with an associated certification process. Interactions and interdependencies within the SNET group 900 may involve one or more of an adaptive resource management, allocation and arbitration module 920, an association/control module 922, and a SNET group member profiling module 924.

Distribution of internal and external SNET content/media 926 can be accomplished in a variety of ways in accordance with various embodiments. For example, media distribution may involve an adaptive or parallel network routing infrastructure involving a wide variety of communication protocols and wired and/or wireless communications channels. SNET content/media 926 may comprise, for example, various user-driven (advertising) channels, pictures, videos, links, online text, etc. Access to such content, as well as communications with and remote access to social devices 902 of the SNET group 900, may occur over an Internet backbone 928, cellular communication system, WAN, LAN, etc.

As noted above, a member of a SNET in accordance with various embodiments such as those disclosed herein may establish permissions and/or privacy settings that control and restrict who or what may access the member's resources, applications, services, profile(s) information, identities, connections and groups, as well as define desired degrees of access. Permissions may enable the user to maintain certain information as private or available on a permissive basis only. For example, visibility of specified user information, such as contact information for communication via certain applications, may be limited to users/devices in a SNET(s). Alternatively, specified user information may be publicly available. Likewise, a SNET member may selectively decide to permit others to access personal information such as name, gender, contact information/email address, etc.

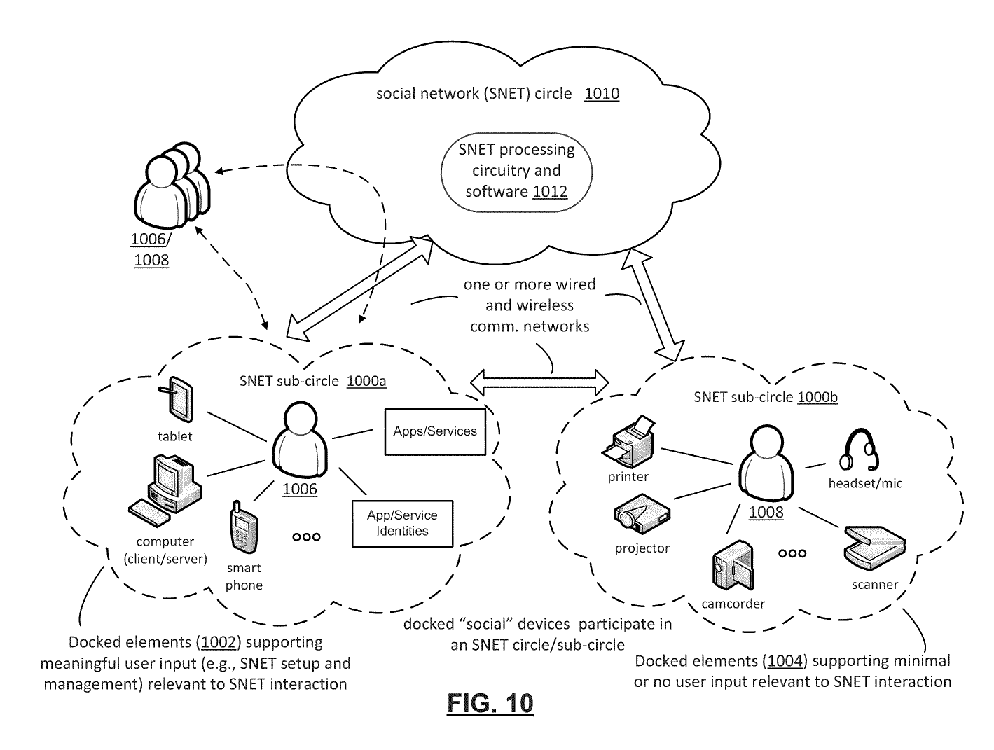

FIG. 10 illustrates various embodiments of membership and accessibility in social network groups/sub-groups in accordance with various embodiments. In some embodiments, membership in a SNET group 1010 may be extended to encompass public and private social devices, social resources, applications, services, equipment, and the like. For example, in a SNET group 1010 that includes human members 1006/1008, each human member may have a respective personal SNET sub-group 1000(a)/1000(b) of associated or docked social devices, social resources, applications, services, and the like 1006/1008 capable of independent or aggregated participation in the SNET group 1010. As shown in the illustrated embodiment, docked social resources can include, without limitation, various identity information associated with various applications and services. The identity information, in some embodiments, can be associated with a user account of the applications and services. Docked applications and services can include, without limitation, third-party applications and services, applications and services hosted by a SNET member, or the like. As described above, the SNET sub-group may be locally or remotely accessible by a human member 1006/1008 and/or other SNET group/sub-group members through various means, such as clicking on an icon or tag associated with the human member/personal sub-group.

Although SNET sub-groups 1000(a) and 1000(b) are illustrated as separate sub-groups, such sub-groups may instead comprise a single SNET group or sub-group, or any number of additional SNET groups, SNET sub-groups, or the like, each of which may include various combinations of social devices 1002/1004. Further, SNET processing circuitry and software 1012 of the illustrated embodiment manages formation and operation of the SNET group 1010. The SNET processing circuitry and software 1012, in some embodiments, can be incorporated in a standalone server, social devices, and/or cloud-based resources. The SNET processing circuitry and software 1012 can, in some embodiments, comprise a processing system that itself comprises a plurality of instances of processing circuitry distributed among multiple server devices, computers, nodes, some combination thereof, or the like. The SNET group 1010 may be persistent or of limited duration, and include ad hoc and/or static associations.

Docked elements 1002/1004 in the illustrated embodiment may be broadly categorized as (i) docked elements 1002 that support user input relevant to SNET interaction, (ii) docked elements 1004 that support minimal or no user input relevant to SNET interaction, some combination thereof, or the like. More particularly and without limitation, the first category may include computers, tablet devices, IPTVs, IPTV set top boxes, smart phones, servers, laptops, cloudbooks, network attached storage devices, gaming consoles, media players/sources, communication nodes (access points, routers, switches, gateways, etc.), user interface devices, power line communication (PLC) devices, etc. In addition, as shown in the illustrated embodiment, the first category 1002 can include various applications and services, identities associated with various applications and services, some combination thereof, or the like. Such docked elements may support SNET management. The second category may include, again without limitation, printers, projectors, cameras and camcorders, scanners, speakers, headsets, smoke detectors, alarm systems, video cameras, mice, etc. In general, dockable social devices include, without limitation, any electronic device that could be operably coupled to or docked in a SNET group/sub-group via wired or wireless pathways to participate as a SNET member.

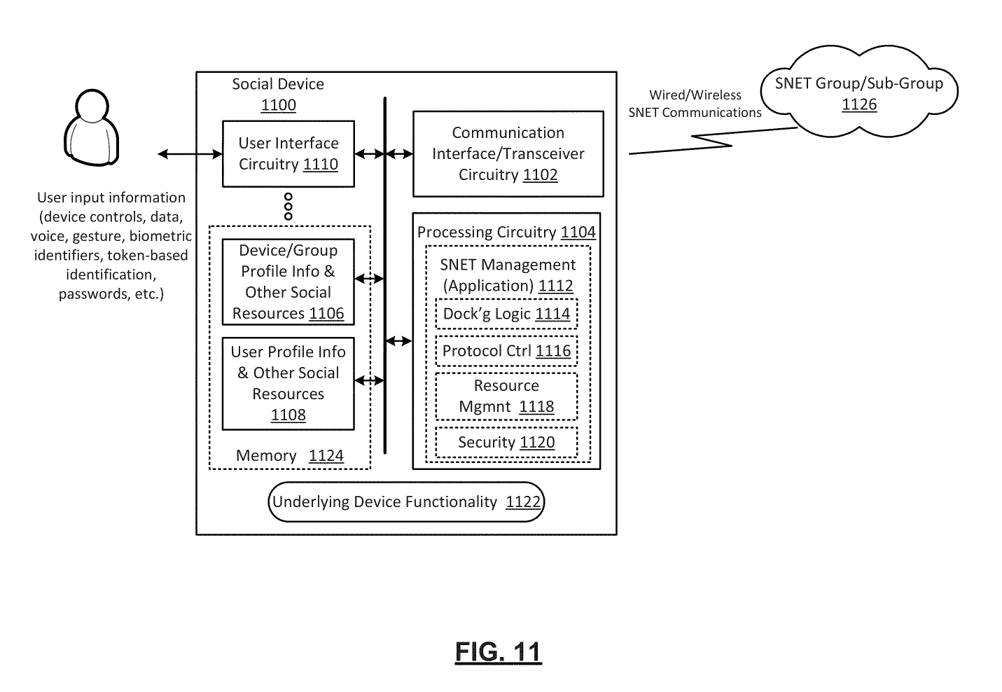

FIG. 11 is a schematic block diagram of an embodiment of a social device comprising integral functionality operable to support social network circle/sub-circle membership and communications in accordance with various embodiments. In the illustrated embodiment, a communication interface and transceiver circuitry 1102 is operable to perform wired or wireless communications between the social device 1100 and a SNET group/sub-group 1126 over one or more communication channels. Depending on the capabilities and configuration of the social device 1100, communications with a SNET may be unilateral or bidirectional/interactive, and utilize either a proprietary or standardized communication protocol. Communications may include, for example, device profile information, user and SNET circle profile information, control signals, media content, interactions with hosted service data, user data, relayed information, etc.

The social device 1100 further includes processing circuitry 1104 operable to process and manage communications, services and associations between the device and other entities including members of a SNET group/sub-group 1124, third parties, software agents, etc. More particularly, the processing circuitry 1104 may include, for example, a software management application 1112 comprising one or more of docking logic 1114 (including support for device discovery and configuration protocols), communication protocol control 1116, resource management 1118, and security/authentication 1120 functionality.

The social device 1100 further may utilize social resources that may take many forms and be maintained in static or dynamic memory 1124. Such social resources can include, without limitation, user profile and contact information associated with various applications and services, the applications and services themselves, and the like. For example, social resources can include profile information that enables a social device and/or user to present an image of itself and its capabilities to other members of a SNET, receive communications from various members of a SNET via a particular third-party application or service, and the like. Social resources included in memory 1124 can include, without limitation, device/group profile information 1106, user profile information 1108, and the like may be utilized in various ways in accordance with the disclosure to facilitate a variety of social interactions. Depending on the capabilities and requirements of a particular device (and other members of a SNET), a device or user profile may be static or dynamic.

In certain embodiments, the social device 1100 may interact with a user(s) via user interface circuitry 1110. User input to the social device 1100 may include, for example, data entry through a keypad, touchscreen, remote control device, gaming controller, device control buttons, voice or gesture commands, storage device, etc. Authorized access to or control of the social device 1100 (as well as resources of an affiliated SNET) can be facilitated through unique biometric identifiers, passwords, token-based identification, trusted authorities or documents such as a driver's license or passport, and like authentication means.

The social device 1100 may perform core or underlying functionality 1120, (e.g., a social appliance, security device, vehicular communication node, etc.). Alternatively, the social device may primarily function as a social networking interface or communication device, or be programmable to perform specific functions within a SNET group/sub-group.

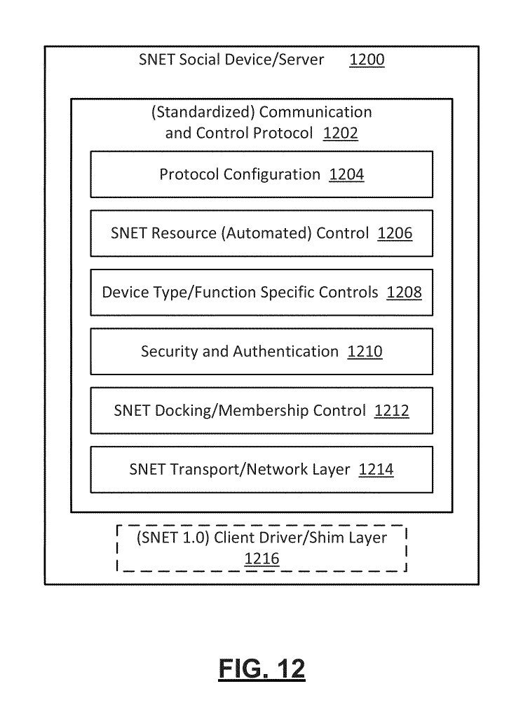

FIG. 12 is a schematic block diagram of a social device/server 1200 utilizing a communication and control protocol 1202 that enables various SNET resource and control operations in accordance with various embodiments. In the illustrated embodiment, the communication and control protocol 1202 comprises protocol configuration 1204, SNET resource (automated) control features 1206, device type/function specific controls 1208, security and authentication features 1210, SNET docking/membership control 1212, and a SNET transport/network layer 1214. Various packetization and encapsulation techniques may be utilized for communicating and receiving control signals and data.

In one embodiment, the social device/server 1200 includes a shim layer or client driver 1216 that enables communications with a central SNET management node, SNET infrastructure, one or more processing systems, SNET members and other compatible devices, including social devices that may not fully support a SNET group communication protocol, some combination thereof, or the like. The shim layer or client driver 1216 may be installed through a SNET node or local storage, or downloaded from a manufacturer website or cloud-based resource. Such installation may occur automatically upon power up or activation of the social device/server 1200 or as directed by other SNET nodes.

Management of and access to SNET resources utilizing the communication and control protocol 1202 may be performed by a central management node of a SNET group or SNET hosting infrastructure. The central management node may include integrated artificial intelligence and/or present itself through a “persona” or “avatar”. In addition, distributed and delegated control mechanisms, including ad hoc or remote operations that span one or more SNETs, permit one member to interact with their own or another member's social devices via a SNET or SNET defined pathways.

In some embodiments, a standardized version of communication and control protocol 1202—referred to herein as a “SNET 1.0” standard for sake of brevity—is employed to facilitate such SNET interactions (and possibly obviate the need for a shim layer in compliant social devices having defined device type characteristics). Various control operations according to a SNET 1.0 standard may include automated and ad hoc SNET group association, as well as support functions such as automated SNET resource offerings, automated device registration and configuration, upgrade and update maintenance, device-to-device communication session management, tunneling/encapsulation functions, proxy services, social resource allocation, etc. For example, through docking of an affiliated social device in a SNET group, a member may desire to access and control their own remote docked devices, as well as remote docked devices of other members, either directly or via a further user device. In some embodiments, such interaction may be facilitated through a SNET 1.0 compliant approach.

SNET 1.0 compliant devices may be designated as “SNET 1.0 Certified”, for example, and provide both system-on-a-chip (“SoC”)/hardware and software support peculiar to a particular device family. By way of example, a SNET 1.0 Certified NAS might have storage related, defined control capabilities that include default access tier definitions as described herein, security and DRM features, etc. Such control capabilities differ from, for example, a SNET 1.0 Certified STB (which might have multiple tuners/pipelines for delivering streaming video with certain tuners/pipelines reserved for the device owner according to a setup procedure). Social devices may be configured, manually or through factory-staged settings and security, to delegate membership control to a SNET (1.0) group/server for further applications such as those described herein.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present disclosure. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. A social networking system that supports interactions with a first human member and a second human member, the social networking system comprising:
a management service that supports a first docking process involving associating a first social networking group with a first identity of the first human member; and
the management service supports a social pathway via the first social networking group through which the second human member can interact with the first identity.

2. The social networking system of claim 1, wherein:
the first identity is a handle associated with an application; and
the management service supports the social pathway via the first social networking group through which the second human member can interact with the application via the first identity.

3. The social networking system of claim 2, the application is a third-party application.

4. The social networking system of claim 2, wherein:
the application is an operation scheduling application; and
the management service supports interactions between the application and the second human member, the interactions include the application sending an indication of a schedule of operations to the second human member.

5. The social networking system of claim 4, the management service supports sending the indication to the second human member in response to a determination that a device supporting the second human member is within a certain proximity to a location associated with the device, the indication is sent to be presented to the second human member via an interface associated with the device.

6. The social networking system of claim 4, the account associated with the communication service is transparent to the second human member.

7. The social networking system of claim 1, wherein:
the first identity identifies an account of a communication service; and
the management service supports the social pathway via the first social networking group through which the second human member can communicate with the first human member via the account associated with the communication service.

8. A device that supports a first member of a social networking system, the device comprising:
an interface operable to communicatively couple with the social networking system; and
processing circuitry interoperable with the interface to:
interact with the social networking system in a first docking process to dock an application to a first social networking group, the application is associated with the first member; and
manage access to the application by a membership of the first social networking group via a social pathway associated with the first social network group.

9. The device of claim 8, the processing circuitry interoperable with the interface to extend access to the application by at least one member of the first social networking group through a representative view of the application provided to the at least one member.

10. The device of claim 8, the processing circuitry interoperable with the interface to manage access to the application by at least one member of the first social networking group based, at least in part, upon a physical location associated with the at least one member.

11. The device of claim 10, the processing circuitry interoperable with the interface to respond to a determination that a device associated with the at least one member is in a certain physical proximity to a location by supporting interactions between the application and the at least one member.

12. The device of claim 8, the processing circuitry interoperable with the interface to interact with the social networking system in a second docking process to dock an identification handle to the first social networking group, the identification handle is associated with the first member identifies an account associated with a third-party application.

13. A social networking management system that supports a plurality of members, the plurality of members including a first human member and a second human member, the social networking management system comprising:
a processing system operable to support a first docking process, the first docking process involving associating a first social networking group with an application associated with the first human member; and
the processing system operable to also support interactions between the application and the second human member via the first social networking group.

14. The social networking management system of claim 13, the processing system operable to support interactions between the application and the second human member based upon access rules received from the first human member.

15. The social networking management system of claim 13, the first docking process involving associating the first social networking group with the application in response to identifying an association between the application and a device of the first human member.

16. The social networking management system of claim 13, the processing system prioritizes interactions between the first human member and the membership of the first social networking group based upon selected priorities assigned to each of at least some of the membership.

17. The social networking management system of claim 16, the processing system responds to determining that the second human member is attempting to communicate with the first human member, via a social pathway provided by the first social networking group, while the first human member is communicating with at least one other member of the first social networking group by sending an interrupt indication to the first human member.

18. The social networking management system of claim 17, the processing system sends the interrupt notification in response to determining that a high priority is assigned to the second human member.

19. The social networking management system of claim 16, the processing system responds to determining that the second human member is attempting to communicate with the first human member, via a social pathway provided by the first social networking group, while the first human member is communicating with at least one other member of the first social networking group by recording a communication attempt associated with the second human member and presenting an indication of the attempt to the first human member upon completion of the communication with at least one other member of the first social networking group.

20. The social networking management system of claim 19, the indication includes a plurality of recorded communication attempts organized according to relative priorities assigned to members associated with each of the pluralities of recorded communication attempts.
